(19) United States
(12) Patent Application Publication
(10) Pub. No.: US 2008/0076289 A1
(43) Pub. Date: Mar. 27, 2008

(54) Structure of Connnectors

(76) Inventors: Yueh-Hua Hsu Huang, Chung-Ho City (TW); Lien-Huang Yang, Chung-Ho City (TW)

Correspondence Address: HDSL, 4331 STEVENS BATTLE LANE, FAIRFAX, VA, 22033, US

(21) Appl. No.: 11/530,899

(22) Filed: Sep. 11, 2006

(51) Int. Cl. H01R 13/625

(52) U.S. Cl. 439/347

(57) ABSTRACT

A structure of connectors includes a fixed portion and a movable portion. Two hooks of the fixed portion allows for accommodating the cylinders of the push-and pull means of a movable portion, and the connecting terminals of the fixed portion and the connecting terminals of the movable portion are disposed correspondingly for temporal corresponding combining the fixed portion and the movable portion. In case that on-state contact is desired, the picking shaft may be picked downward to the end so that the connecting terminals and a pushing bar of the movable portion start to slide toward the fixed portion and, as sliding to a definite position, the connecting terminals of the movable portion and the connecting terminals of the fixed portion contact each other tightly while the pushing bar can stand up against a holding part disposed in the fixed portion, with the holding part simultaneously standing up against a metal reed of the fixed portion, the metal reed contacting another metal reed so as to form an on-state connection for the connecting terminals of the connectors.

### BACKGROUND OF THE INVENTION

1. Field of the Invention

The present invention relates to an improved structure of connectors and, more specifically, to an improved structure of connectors in which two connecting terminals connected to each other are designed to be a conical terminal and an inner-conical terminal with the area of contact for the two connecting terminals increased effectively after contacting so that bad contact can not be produced easily as the two connecting terminals are connected to each other.

2. Description of the Prior Art

Generally the connectors have a variety of forms, which can be described in FIG. 1. In FIG. 1, a guide plate 1 has a connector 11 disposed thereon, the connector 11 has a socket 111 disposed thereon, and the socket 111 has a connecting cable 12 plugged therein, wherein the connecting cable 12 has an plugging terminal 121 being a jaw-like body in slightly arched state and, when the plugging terminal 121 of the connecting cable 12 is plugged into the socket 111, the area of contact is point-like due to the plugging terminal 121 as being a jaw-like body in arched state; however, in case of long-term usage, perhaps the plugging terminal 121 of the connecting cable 12 may undergo plugging for a long time, which ultimately results in elastic fatigue of the jaw-like body of the plugging terminal 121 so that the connector 11 and the connecting cable 12 are in bad contact; and, moreover, the user may occasionally pull or kick the connecting cable 12 with little care, making the plugging terminal 121 of the connecting cable 12 departing from the socket 111 of the connector 11. Thus, conventional connectors have a lot of inconvenience and are certainly troublesome for the users.

Accordingly, the conventional connectors described above still have a great deal of drawbacks and require an improvement.

The inventors of the application have endeavored to innovate in view of the various shortcomings derived from the aforesaid conventional connectors and, eventually, developed the present improved structure of connectors successfully through years of exhausting research.

### SUMMARY OF THE INVENTION

The present invention is to provide an improved structure of connectors in which two connecting terminals connected to each other are designed to be a conical terminal and an inner-conical terminal with the area of contact for the two connecting terminals increased effectively after contacting so that bad contact can not be produced easily as the two connecting terminals are connected to each other.

The present invention is to provide an improved structure of connectors in which two cylinders of the push-and pull means of a movable portion are hooked in two hooks of a fixed portion and, by picking the push-and pull means with a picking shaft so as to synchronously make the cylinders of the push-and pull means hook in the hooks tightly, the connecting terminals of the movable portion and the fixed portion contact each other tightly, and by picking downward the picking shaft to the end, the pushing bar of the movable portion stands up against and drives a holding part to slide backward, which, in turns, simultaneously make a metal reed contact another metal reed, so that an on-state contact is achieved.

The present invention is to provide an improved structure of connectors in which in case that the on-state contact is not required and simply picking upward the picking shaft to the end is performed, the pushing bar of the movable portion slides backward and the holding part, under the restoring force of the spring, slides in the direction toward the pushing bar and now does not stands up against the metal reed, which returns to the original position, that is, on-state contact does not occur, so that the users need not disassemble the connectors for which the purpose for connecting terminals to be on-state can be achieved as required.

The present invention is to provide an improved structure of connectors having the characteristic that the connecting terminals of the connectors contact tightly, for which the users need not worry about the occurrence of coming off or separating from being kicked for the connecting terminals of the connectors.

A fixed portion comprises a fixed body, a spring, a holding part, two metal reeds, two first connecting terminals, two gaskets and two locking parts. The fixed body has two hooks extending from the front side thereof and a chute penetrates between the two hooks, the chute allowing the holding part with the spring for performing sliding motion therein, two rabbets corresponding up and down to each other being disposed, each on one side over the chute, the two rabbets accommodating the first and second metal reeds, respectively, for the first and second metal reeds to be disposed up and down, and the first metal reed disposed down having a bulged portion formed at an appropriate position thereof, and the fixed body has two grooves, each disposed on one side thereof and allowing that one of the first connecting terminals with thread is mounted therein for one of the gasket to be put around and one of the locking parts to be locked on the thread of said first connecting terminal as the thread having gone through the grooves; a movable portion, comprising a movable body, two second connecting terminals, two collars, a picking shaft, a push-and-pull means and two pivots, wherein the movable body has a protrusion extending from the front side thereof, the protrusion having spindle holes disposed thereon, a pushing bar extending from the rear side thereof, the pushing bar standing up against the front side of the holding part, and two open holes, each disposed on one side thereof and allowing that one of the second connecting terminals is mounted therein and thus disposed corresponding to said first connecting terminal for one of the hollow collars to be put around the rear end of said second connecting terminal as said second connecting terminal having gone through the open hole so as for said second connecting terminal to be wedged and secured by the collar, and, thus, the picking shaft with two spindle holes is mounted within the protrusion, for the spindle holes of the picking shaft to be pivot-jointed to the spindle holes of the protrusion by one of the pivots and for the other spindle holes of the picking shaft to be pivot-jointed to the spindle holes on one end of the push-and-pull means by the other one of the pivots, and the other end of the push-and-pull means has two cylinders, each disposed on one side thereof for hooking in one of the hooks; and, furthermore, the connecting portions of the second connecting terminals can be made as a conical end and an inner-conical end. The members described above, the improved structure of connectors of the present invention can be formed.

These features and advantages of the present invention will be fully understood and appreciated from the following detailed description of the accompanying drawings.

### BRIEF DESCRIPTION OF THE DRAWINGS

FIG. 1 is an exploded perspective view of a conventional connector;

FIG. 2 is an exploded perspective view of the improved structure of connectors of the present invention;

FIG. 3 is an exploded combinational view of the improved structure of connectors in FIG. 2; and

FIGS. 4A, 4B and 4C are implemented sectional schematic diagram of the improved structure of connectors.

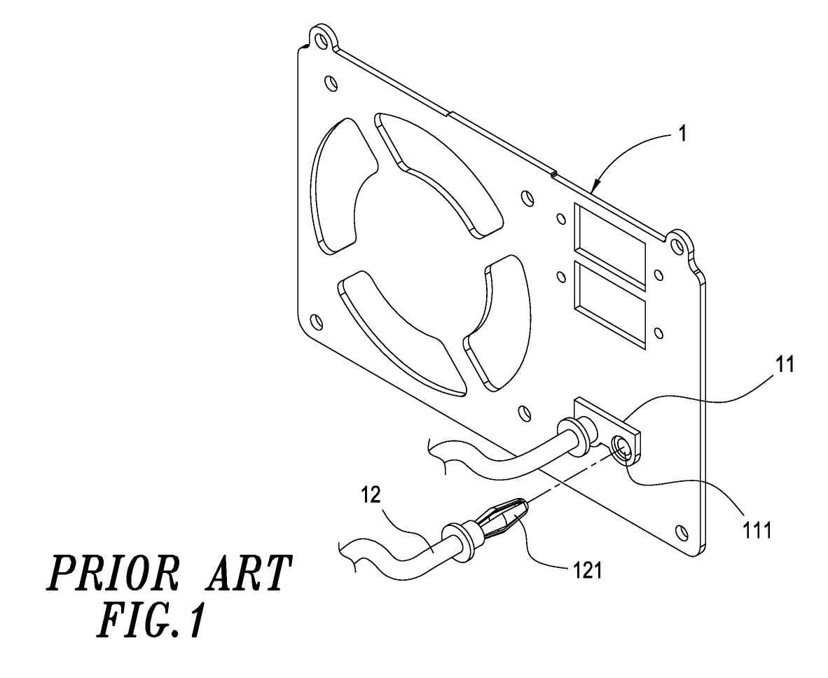

### DETAILED DESCRIPTION OF THE EMBODIMENTS

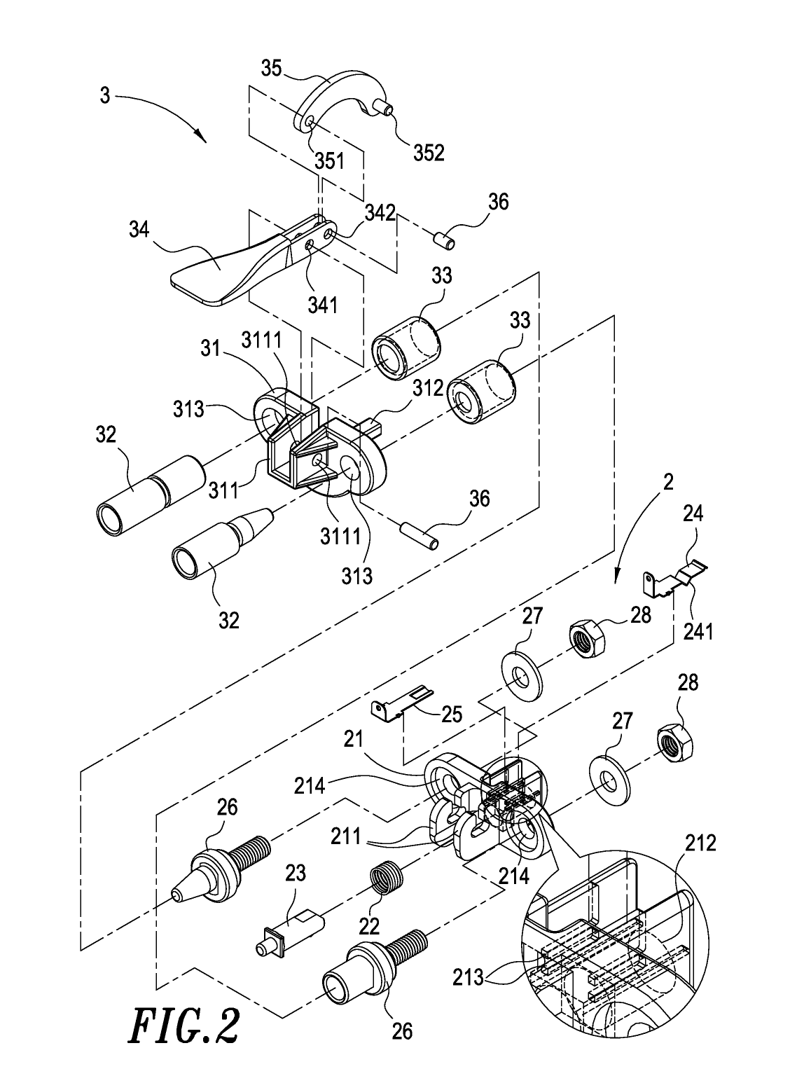

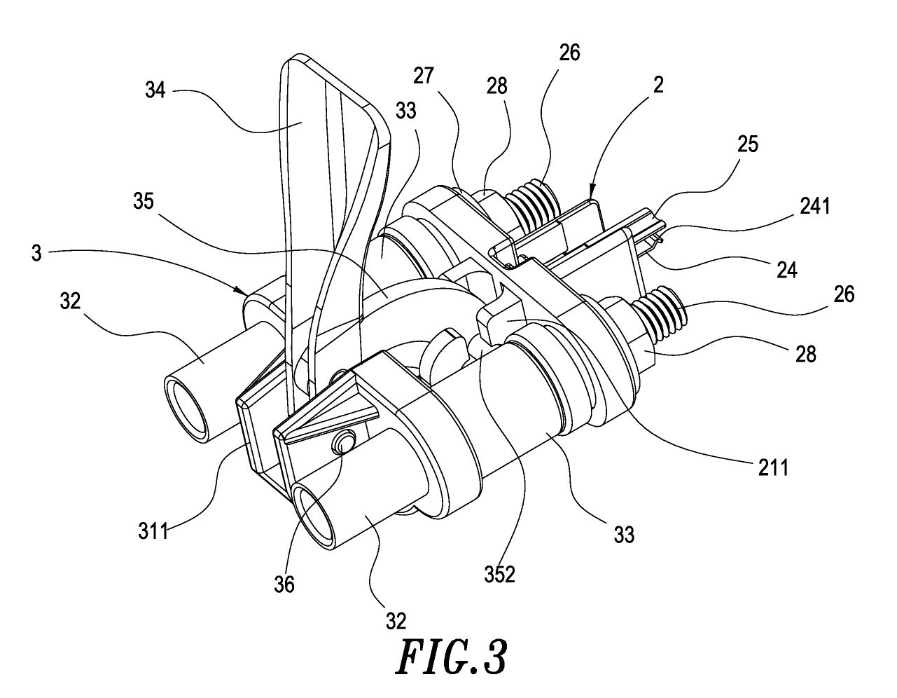

Referring to FIGS. 2 and 3, the improved structure of connectors provided in the present invention comprises a fixed portion 2 and a movable portion 3.

The fixed portion 2 comprises an fixed body 21, a spring 22, a holding part 23, a first and a second metal reeds 24 and 25, two first connecting terminals 26, two gaskets and two locking parts. The fixed body 21 has two hooks 211 extending from the front side thereof and a chute 212 penetrates between the two hooks 211, the chute 212 allowing the holding part 23 with the spring 22 for performing sliding motion therein, two rabbets 213 corresponding up and down to each other being disposed, each on one side over the chute 212, the two rabbets 213 accommodating the first and second metal reeds 24 and 25, respectively, for the first and second metal reeds 24 and 25 to be disposed up and down, and the first metal reed 24 disposed down having a bulged portion 241 formed at an appropriate position thereof, and the fixed body 21 has two grooves 214, each disposed on one side thereof and allowing that one of the first connecting terminals 26 with thread is mounted therein for one of the gasket 27 to be put around and one of the locking parts 28 to be locked on the thread of said first connecting terminal 26 as the thread having gone through the grooves 214, so that the holding part 23 can perform a sliding motion within the chute 212, and, furthermore, the connecting positions of the first connecting terminals 26 can be made as a conical end and an inner-conical end, respectively, and the locking parts 28 can be nuts or other fasteners; and

The movable portion 3 comprises a movable body 31, two second connecting terminals 32, two collars 33, a picking shaft 34, a push-and-pull means 35 and two pivots 36, wherein the movable body 31 has a protrusion 311 extending from the front side thereof, the protrusion 311 having spindle holes 3111 disposed thereon, a pushing bar 312 extending from the rear side thereof, the pushing bar 312 standing up against the front side of the holding part 23, and two open holes 313, each disposed on one side thereof and allowing that one of the second connecting terminals 32 is mounted therein and thus disposed corresponding to said first connecting terminal 26 for one of the hollow collars 33 to be put around the rear end of said second connecting terminal 32 as said second connecting terminal 32 having gone through the open hole 313 so as for said second connecting terminal 32 to be wedged and secured by the collar 33, and, thus, the picking shaft 34 with two spindle holes 341 and 342 is mounted within the protrusion 311, for the spindle holes 341 of the picking shaft 34 to be pivot-jointed to the spindle holes 3111 of the protrusion 311 by one of the pivots 36 and for the other spindle holes 342 of the picking shaft 34 to be pivot-jointed to the spindle holes 351 on one end of the push-and-pull means 35 by the other one of the pivots 36, and the other end of the push-and-pull means 35 has two cylinders 352, each disposed on one side thereof for hooking in one of the hooks 211, and, furthermore, the connecting portions of the second connecting terminals 32 can be made as a conical end and an inner-conical end.

The members described above, the improved structure of connectors of the present invention can be formed.

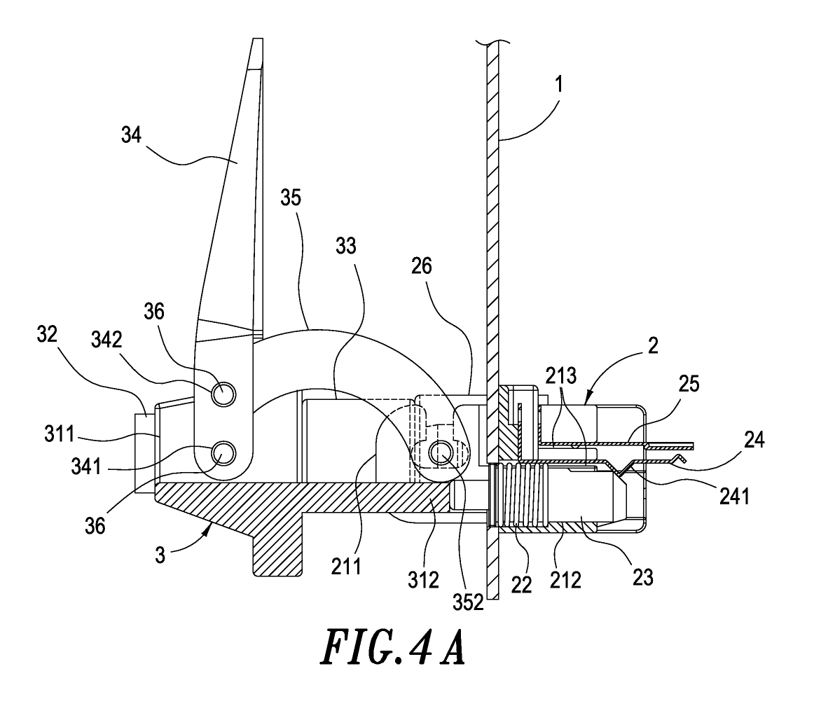

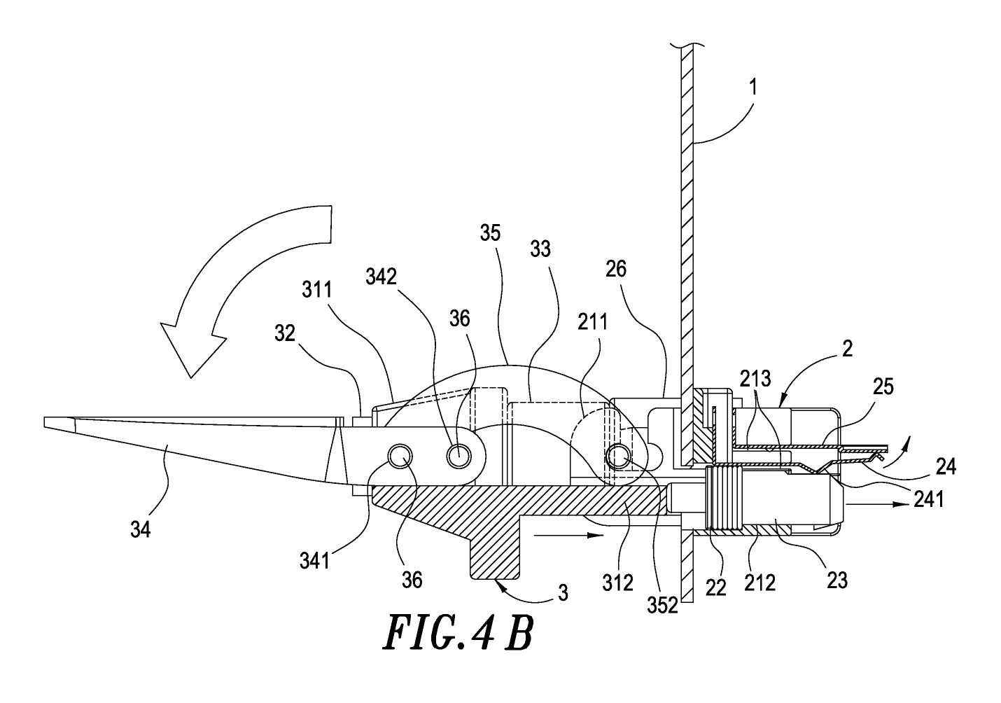

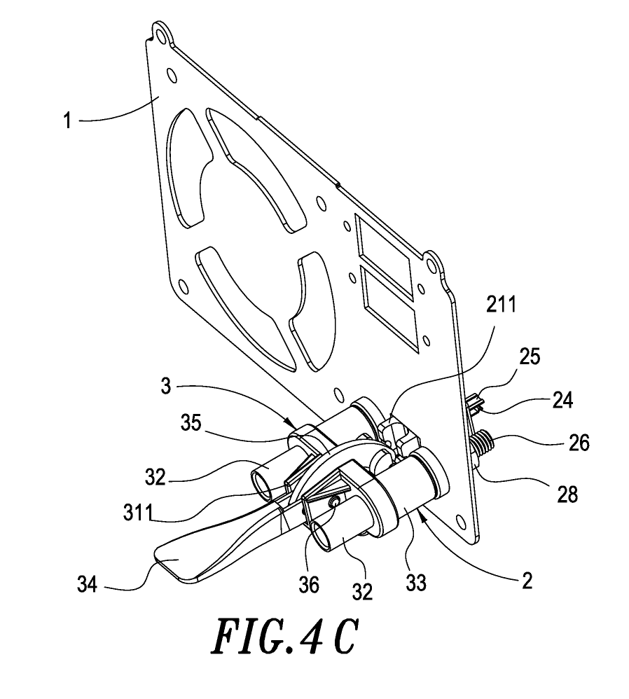

Referring to FIGS. 4A, 4B and 4C, which are implemented sectional schematic diagram of the improved structure of connectors. First, the fixed portion 2 is secured on the guide plate 1 and then cylinders 352 of a movable portion 3 are hooked in hooks 211 of the fixed body 21, so that first connecting terminals 26 and second connecting terminals 32 are disposed correspondingly, as shown in FIG. 4A; in case that on-state connection is desired, the picking shaft 34 may be picked downward to the end and now the pushing bar 312 can stand up against one end of a holding part 23, which can pass inward upon being forced with the other end simultaneously standing up against a bulged portion 241 of a first metal reed 24, so that the first metal reed 24 raises to contact a second metal reed 25 so as to form an on-state connective loop, as shown in FIGS. 4B and 4C; on the contrary, when the pushing bar 312 does not stand up against the holding part 23 continuously, it is simply required to pick upward the picking shaft to the end and now the pushing bar 312 does not stand up against one end of the holding part 23, which can return to the original position under the restoring force of a spring 22 put around the holding part 23, while the bulged portion 241 of the first metal reed 24 can return to the original position since the holding part 23 does not stand up, so that the on-state contact between the first metal reed 24 and the second metal reed 25 is absent temporarily for another on-state contact; and the first connecting terminals 26 and the second connecting terminals 32 described above can be designed to be a conical terminal and an inner-conical terminal, which has a face-to-face contact between the connecting terminals 26 and 32 with the area of contact increased effectively so that bad contact can not occur easily; and since the connectors is structured with the fixed portion 2 and the movable portion 3 hooking each other the fixed portion 2 and the movable portion 3 can not come off. Thus, the purpose for multiple usages and functions can be achieved by operation in the way described above.

The improved structure of connectors of the present invention has still the following advantages, as compared with other conventional techniques:

1. The present invention provides an improved structure of connectors in which two connecting terminals connected to each other are designed to be a conical terminal and an inner-conical terminal with the area of contact for the two connecting terminals increased effectively after contacting so that bad contact can not be produced easily as the two connecting terminals are connected to each other.

2. The present invention provides an improved structure of connectors in which two cylinders of the push-and pull means of a movable portion are hooked in two hooks of the fixed portion and, by picking the push-and pull means with a picking shaft so as to synchronously make the cylinders of the push-and pull means hook in the hooks tightly, the connecting terminals of the movable portion and the fixed portion contact each other tightly, and by picking downward the picking shaft to the end, the pushing bar of the movable portion stands up against and drives a holding part to slide backward, which, in turns, simultaneously make a metal reed contact another metal reed, so that an on-state contact is achieved.

3. The present invention provides an improved structure of connectors in which in case that the on-state contact is not required and simply picking upward the picking shaft to the end is performed, the pushing bar of the movable portion slides backward and the holding part, under the restoring force of the spring, slides in the direction toward the pushing bar and now does not stands up against the metal reed, which returns to the original position, that is, on-state contact does not occur, so that the users need not disassemble the connectors for which the purpose for connecting terminals to be on-state can be achieved as required.

4. The present invention provides an improved structure of connectors having the characteristic that the connecting terminals of the connectors contact tightly, for which the users need not worry about the occurrence of coming off or separating from being kicked for the connecting terminals of the connectors.

5. The present invention provides an improved structure of connectors that has a simple structure, easy operation and low cost in production.

Many changes and modifications in the above-described embodiment of the invention can, of course, be carried out without departing from the scope thereof. Accordingly, to promote the progress in science and the useful arts, the invention is disclosed and is limited intentionally only by the scope of the appended claims.

What is claimed is:

1. A structure of connectors, comprising:
a fixed portion, comprising a fixed body, a spring, a holding part, two metal reeds, two first connecting terminals, two gaskets and two locking parts, wherein the fixed body has hooks extending from the front side thereof and a chute penetrates between the hooks, the chute allowing the holding part with the spring, two rabbets corresponding to each other being disposed, each on one side over the chute, the two rabbets accommodating the metal reeds, respectively, and one of the metal reed having a bulged portion formed at an appropriate position thereof, and the fixed body has two grooves, each disposed on one side thereof and allowing that one of the connecting terminals with thread is mounted therein for one of the gaskets to be put around and one of the locking parts to be locked on the thread as the thread of the connecting terminal having gone through the grooves; and
a movable portion, comprising a movable body, two second connecting terminals, two collars, a picking shaft, a push-and-pull means and two pivots, wherein the movable body has a protrusion extending from the front side thereof, the protrusion having spindle holes disposed thereon, a pushing bar extending from the rear side thereof, the pushing bar standing up against the front side of the holding part, and two open holes, each disposed on one side thereof and allowing that one of the connecting terminals is mounted therein and thus disposed corresponding to the other connecting terminal for one of the hollow collars to be put around the rear end of the connecting terminal as the connecting terminal having gone through the open hole so as for the connecting terminal to be wedged and secured by the collar, and, thus, the picking shaft with two spindle holes is mounted within the protrusion, for the spindle holes of the picking shaft to be pivot-jointed to the spindle holes of the protrusion by one of the pivots and for the other spindle holes of the picking shaft to be pivot-jointed to the spindle holes on one end of the push-and-pull means by the other one of the pivots, and the other end of the push-and-pull means has two cylinders, each disposed on one side thereof for hooking in one of the hooks.

2. The structure of connectors of claim 1, wherein the holding part performs sliding motion in the chute.

3. The structure of connectors of claim 1, wherein the locking parts can be nuts or other fasteners.

4. The structure of connectors of claim 1, wherein the connecting positions of the first connecting terminals of the fixed portion can be a conical end and an inner-conical end, respectively, so that the connecting terminals have tight contact at the connecting positions.

5. The structure of connectors of claim 1, wherein the connecting positions of the first connecting terminals of the movable portion can be a conical end and an inner-conical end, respectively, so that the connecting terminals have tight contact at the connecting positions.

6. The structure of connectors of claim 1, wherein when the picking shaft is picked downward to the end, the pushing bar of the movable portion stands up against one end of the holding part, which passes inward upon being forced with the other end simultaneously standing up against the bulged portion of the metal reed, so that the metal reed raises to contact another metal reed so as to form an on-state connective loop.

7. The structure of connectors of claim 1, wherein when the picking shaft is picked downward to the end, the pushing bar does not stand up against one end of the holding part, which return to the original position under the restoring force of a spring put around the holding part, while the bulged portion of the first metal reed returns to the original position since the holding part does not stand up, so that the on-state contact between the metal reed is absent temporarily for another on-state contact.
